(19) United States
(12) Patent Application Publication
(10) Pub. No.: US 2018/0101022 A1
(43) Pub. Date: Apr. 12, 2018

(54) SCREWLESS EYEGLASS STRUCTURE

(71) Applicant: GAZELLE CORPORATION, Taipei City (TW)

(72) Inventor: Shang-Tai WU, Taipei City (TW)

(21) Appl. No.: 15/288,566

(22) Filed: Oct. 7, 2016

(51) Int. Cl. G02C 5/22; G02C 5/14

(52) U.S. Cl. CPC G02C 5/2209; G02C 2200/08; G02C 5/146

(57) ABSTRACT

A screwless eyeglass structure includes a frame and two legs. Each of two ends of the frame includes a fastening unit. The fastening unit includes two support arms, an assembly pillar connected to the two support arms, and an assembly hole adjacent to the assembly pillar. One end of each leg has a connection unit assembled with the fastening unit. The connection unit includes a body, a connection plate extending from the body, a guiding plate connected to one end of the connection plate, and a slot disposed in the connection plate. The guiding plate is inserted through the assembly hole to be engaged with the assembly pillar, the connection plate is rotatable with respect to the frame, and the assembly pillar is pivotally connected to the slot. Accordingly, the leg can be assembled to the frame quickly, and an assembly process is simple and time-efficient.

### TECHNICAL FIELD

The present invention relates to an eyeglass structure and, in particular, to a screwless eyeglass structure for assembling legs to the frame without screws.

### BACKGROUND

In the market, there are a variety of eyeglasses, including prescription glasses (for correction of deficient vision), sunglasses, glasses with wind guard, and stylish glasses (for good or trendy appearance). Glasses are a necessity in people's daily life. A conventional eyeglass structure usually includes a frame and two legs. Two lenses are placed in the frame, and two legs are threadedly fastened, with screws by hand tools, to two opposite sides of the frame or the lenses, so that the legs can be positioned and pivoted about the screws to be collapsed.

However, the conventional eyeglass structure mentioned above tends to have problems, like loosened screws, abrasion, loosened legs, or deformation, due to rotation of the legs or vibrations after a long period of use. Then, hand tools, like a screwdriver, must be used to tighten or replace the screws for fastening or repair. On the other hand, if a user/operator does not have suitable hand tools at hand, replacement or repair cannot be done, which causes great inconvenience.

Accordingly, it is the aim of the present invention to solve the above-mentioned problems, on the basis of which the present invention is accomplished.

### SUMMARY

It is an object of the present invention to provide a screwless eyeglass structure whereby a leg can be quickly assembled to a frame without any tools, and an assembly process is simple and time-efficient.

It is another object of the present invention to provide a screwless eyeglass structure with a simple structure for convenient assembly.

Accordingly, the present invention provides a screwless eyeglass structure, comprising a frame and two legs. Each of two ends of the frame includes a fastening unit. The fastening unit includes two support arms, an assembly pillar connected to the two support arms, and an assembly hole adjacent to the assembly pillar. One end of each of the two legs including a connection unit assembled with the fastening unit. The connection unit includes a body, a connection plate extending from the body, a guiding plate connected to one end of the connection plate, and a slot disposed in the connection plate. The guiding plate is inserted through the assembly hole to be engaged with the assembly pillar, the connection plate is rotatable with respect to the frame, and the assembly pillar is pivotally connected to the slot.

According to one embodiment, each of the two legs further includes two fulcrum positioning portions extending outwardly from two sides of the body, and each of the fulcrum positioning portions is in contact against an edge of the respective corresponding one of the support arms.

According to one embodiment, a length of the connection plate is equal to or less than a length of the assembly pillar, and a length between the two fulcrum positioning portions is equal to a length between the two support arms.

According to one embodiment, an edge of each of the support arms is flush with one side of the assembly pillar.

According to one embodiment, the guiding plate is inclined away from the body.

According to one embodiment, each of the legs further includes a bend portion, and the bend portion is bent from the body toward the guiding plate.

According to one embodiment, each of the legs further includes a groove in communication with the slot, and the groove is formed between the bend portion and the body.

According to one embodiment, the connection plate further includes a press surface and a block surface disposed corresponding to each other.

According to one embodiment, the frame further includes a recess disposed corresponding to the block surface, and the block surface makes surface contact with the recess to position the leg.

According to one embodiment, wherein the frame further includes two lenses, and each of the two lenses is integrally formed with the frame.

According to one embodiment, each of the legs further includes a plurality of pads, and each of the pads protrudes from one side surface of the body.

According to one embodiment, the frame and the two legs consist of the same material.

According to one embodiment, when the leg is assembled to the frame, and the connection plate of the leg forms an included angle with respect to the frame.

According to one embodiment, the included angle is in a range from 80 to 120 degrees.

The guiding plate of the leg is inclined an angle away from the body, thus facilitating engaging the guiding plate with the assembly pillar and guiding the assembly pillar into the slot. The length between the two support arms is equal to the length of the connection plate and the length of the guiding plate, so that the guiding plate can be inserted through the assembly hole to be engaged with the assembly pillar, thereby facilitating alignment of the leg with the frame.

An edge of each of the two support arms is flush with one side of the assembly pillar, so that the body of the leg can easily contact one side of the two support arms and the assembly pillar. When the guiding plate is engaged with the assembly pillar, the two fulcrum positioning portions of the body contact the edges of the two support arms. Therefore, when the leg is rotatably assembled to the frame, the leg is pivoted about the two fulcrum positioning portions as a rotation axis, so as to make the assembly pillar slide into the slot along the guiding plate. Accordingly, assembly is completed.

Moreover, when the block surface of the connection plate makes surface contact with the recess of the frame, the leg is limited by a wall surface of the frame, and thereby excessive rotation of the leg is prevented, so that the leg can be fastened securely and effectively.

### BRIEF DESCRIPTION OF THE DRAWINGS

The disclosure will become more fully understood from the detailed description, and the drawings given herein below is for illustration only, and thus does not limit the disclosure, wherein:

FIG. 1 is a perspective view illustrating a screwless eyeglass structure of the present invention;

FIG. 2 is a partial exploded view illustrating the screwless eyeglass structure of the present invention;

FIG. 3 is a partial perspective view illustrating the screwless eyeglass structure before assembly;

FIG. 4 is a partial perspective view illustrating the screwless eyeglass structure after assembly;

FIG. 5 is a partial cross-sectional view illustrating the screwless eyeglass structure before assembly; and

FIG. 6 is a partial cross-sectional view illustrating the screwless eyeglass structure after assembly.

### DETAILED DESCRIPTION

Detailed descriptions and technical contents of the present invention are illustrated below in conjunction with the accompany drawings. However, it is to be understood that the descriptions and the accompany drawings disclosed herein are merely illustrative and exemplary and not intended to limit the scope of the present invention.

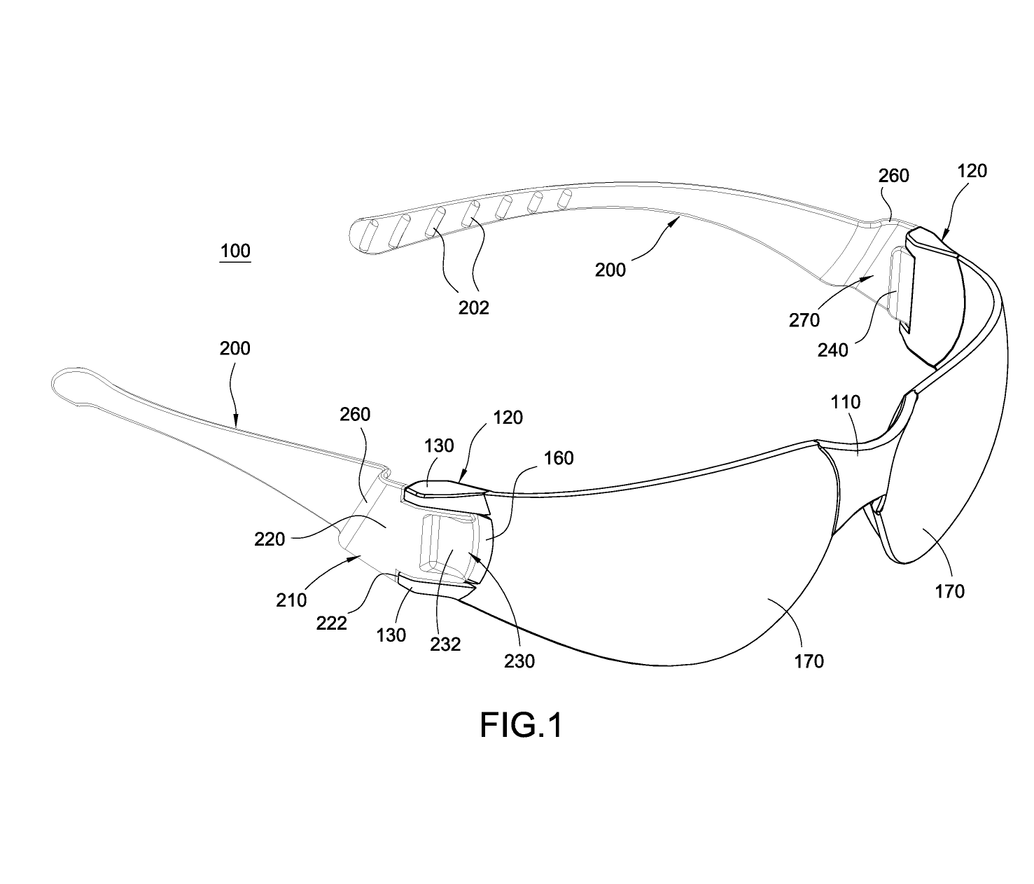

Referring to FIGS. 1 to 4, the present invention provides a screwless eyeglass structure 100, and the screwless eyeglass structure 100 comprises a frame 110 and two legs 200. Preferably, the eyeglasses herein referred to are light-transparent hard plastic glasses, like protective goggles or safety glasses, for protecting eyes from injury due to flying objects when a user/operator is performing cutting, grinding, or other production processes, so as to complete the production processes safely. However, in other different embodiments, the eyeglass structure 100 can be applied to prescription glasses, glasses for good appearance, or functional glasses; the present invention is not limited in this regard.

In the embodiment shown in FIG. 1, the frame 110 further includes two lenses 170. It is preferable that each of the two lenses 170 is integrally formed with the frame 110, and the frame 110 and the lenses 170 all consist of hard plastic or other similar material. Each of the legs 200 further includes a plurality of pads 202, and each of the pads 202 protrudes from one side surface of the body 220 for anti-slipping purposes or enhanced positioning. Moreover, the two legs 200 and the frame 110 consist of the same material, like hard plastic or other similar material.

Each of two ends of the frame 110 includes a fastening unit 120, the fastening unit 120 includes two support arms 130, an assembly pillar 140 connected to the two support arms 130, and an assembly hole 150 adjacent to the assembly pillar 140. The assembly hole 150 is formed among the two support arms 130 and the assembly pillar 140. One end of each of the two legs 200 includes a connection unit 210 assembled with the fastening unit 120. The connection unit 210 includes a body 220, a connection plate 230 extending from the body 220, a guiding plate 240 connected to one end of the connection plate 230, and a slot 250 disposed in the connection plate 230, wherein the guiding plate 240 is inserted through the assembly hole 150 to be engaged with the assembly pillar 140, the connection plate 230 is rotatable with respect to the frame 110, and the assembly pillar 140 is pivotally connected to the slot 250.

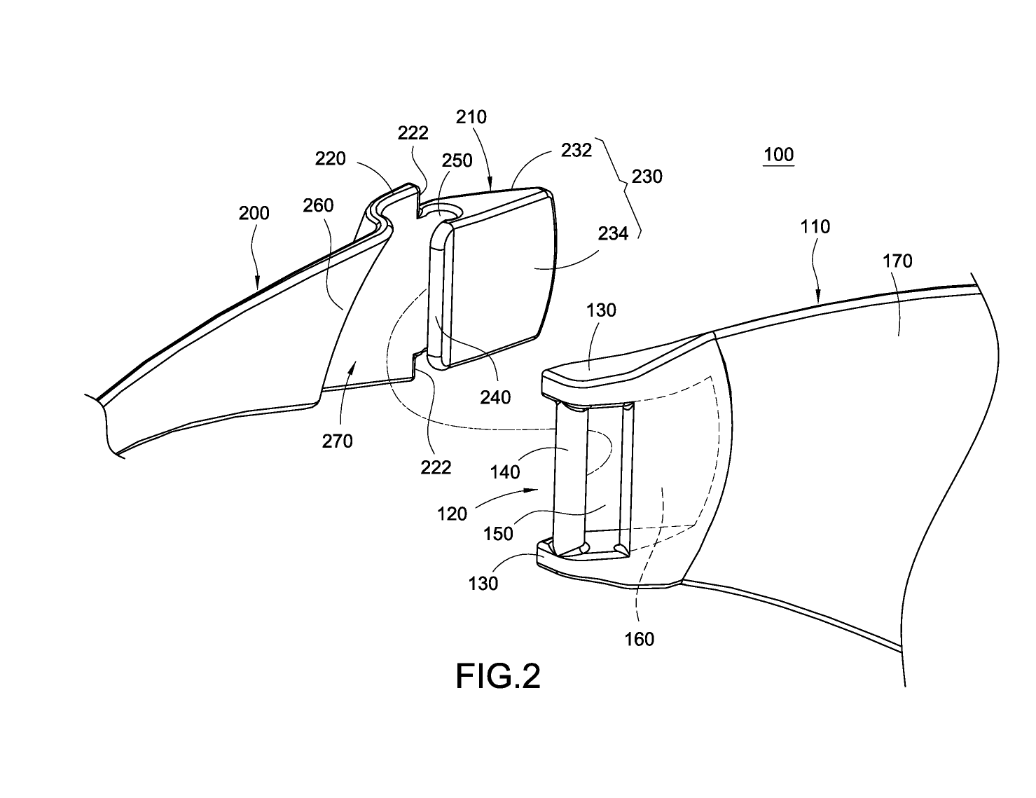

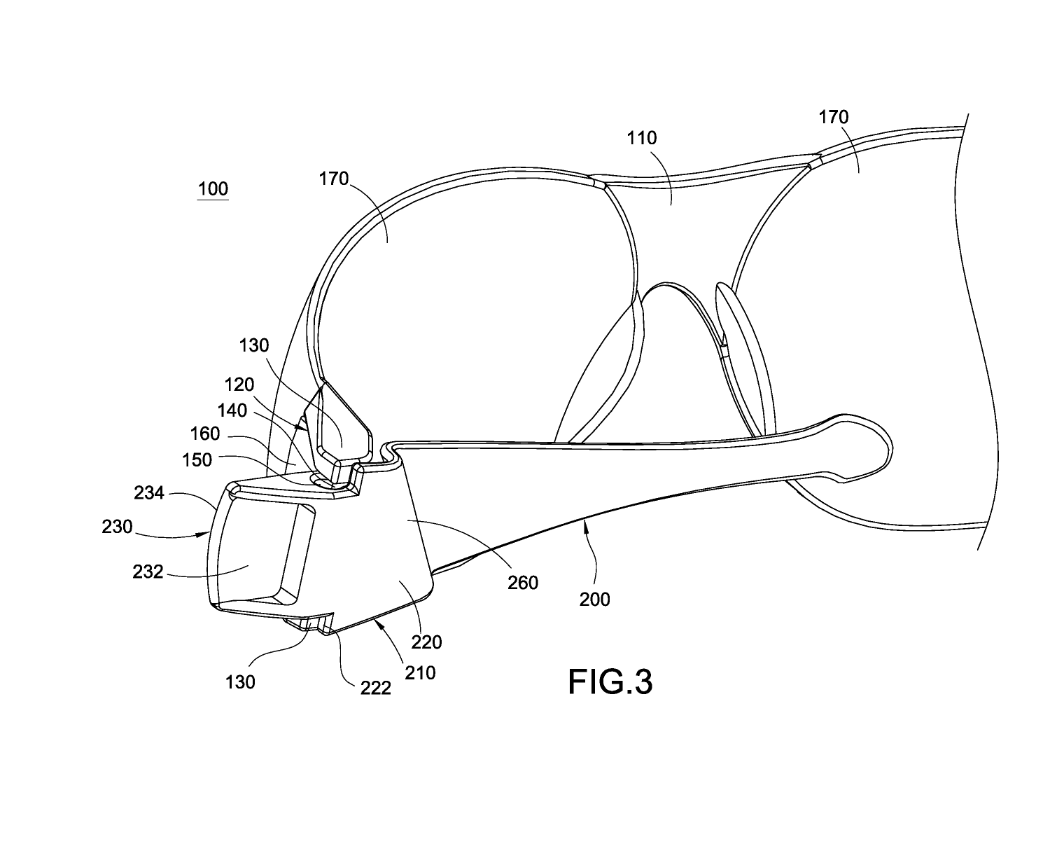

As shown in FIGS. 2 and 3, an edge of each of the support arms 130 is preferably flush with one side of the assembly pillar 140, so that the edge of the support arm 130 of the fastening unit 120 can contact against the body 220 of the connection unit 210, and the guiding plate 240 is engaged with the assembly pillar 140, and thereby the legs 200 are rotatably assembled onto the frame 110. A detailed description about assembly is provided below.

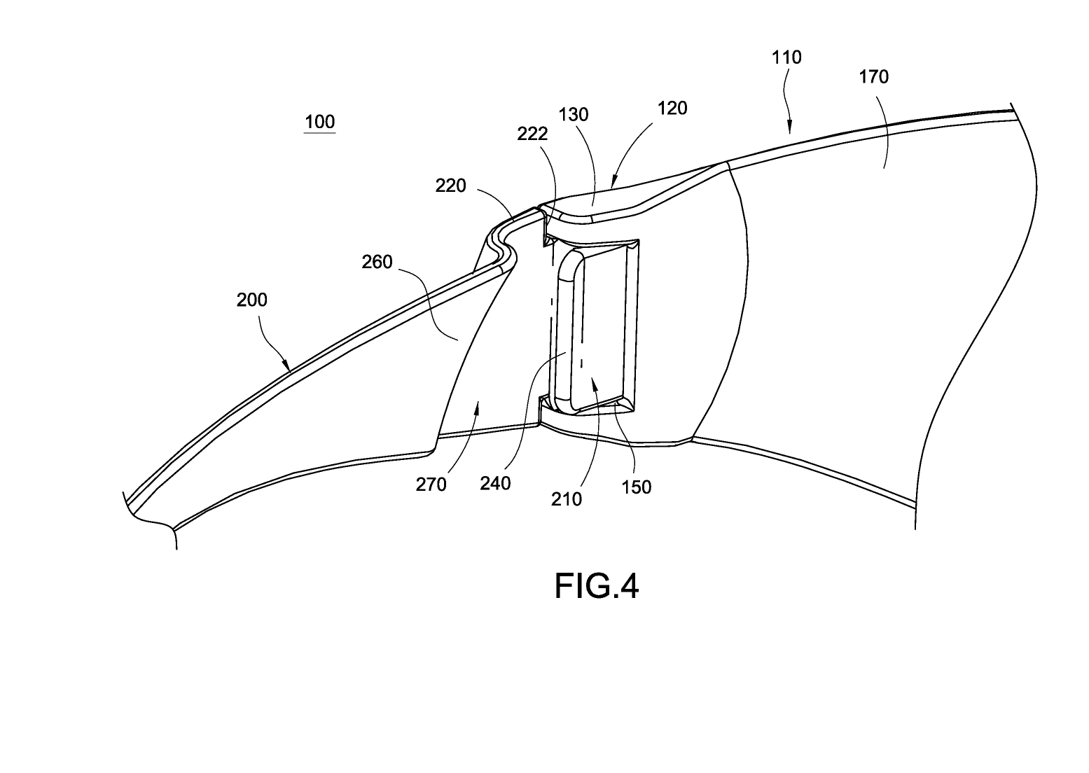

Each of the two legs 200 further includes two fulcrum positioning portions 222 extending outwardly from two sides of the body 220, and each of the fulcrum positioning portions 222 is in contact against the edge of the respective corresponding one of the support arms 130. As shown in FIGS. 3 and 4, a length of the connection plate 230 is equal to or less than a length of the assembly pillar 140, and is less than a length between the two support arms 130, so that the connection plate 230 can be connected between the two support arms 130. Moreover, a length between the two fulcrum positioning portions 222 is substantially equal to the length between the two support arms 130. Therefore, the screwless eyeglass structure 100 gradually increases in size from the legs 200 to the frame 110, thus facilitating a user's holding or wearing of the screwless eyeglass structure 100.

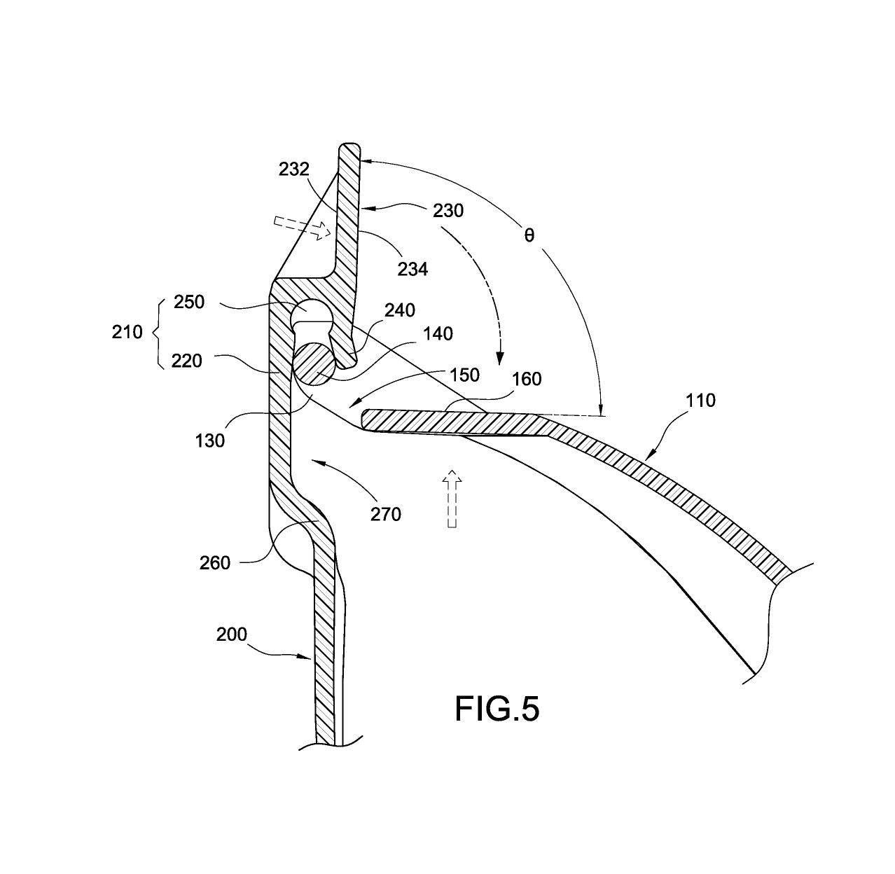

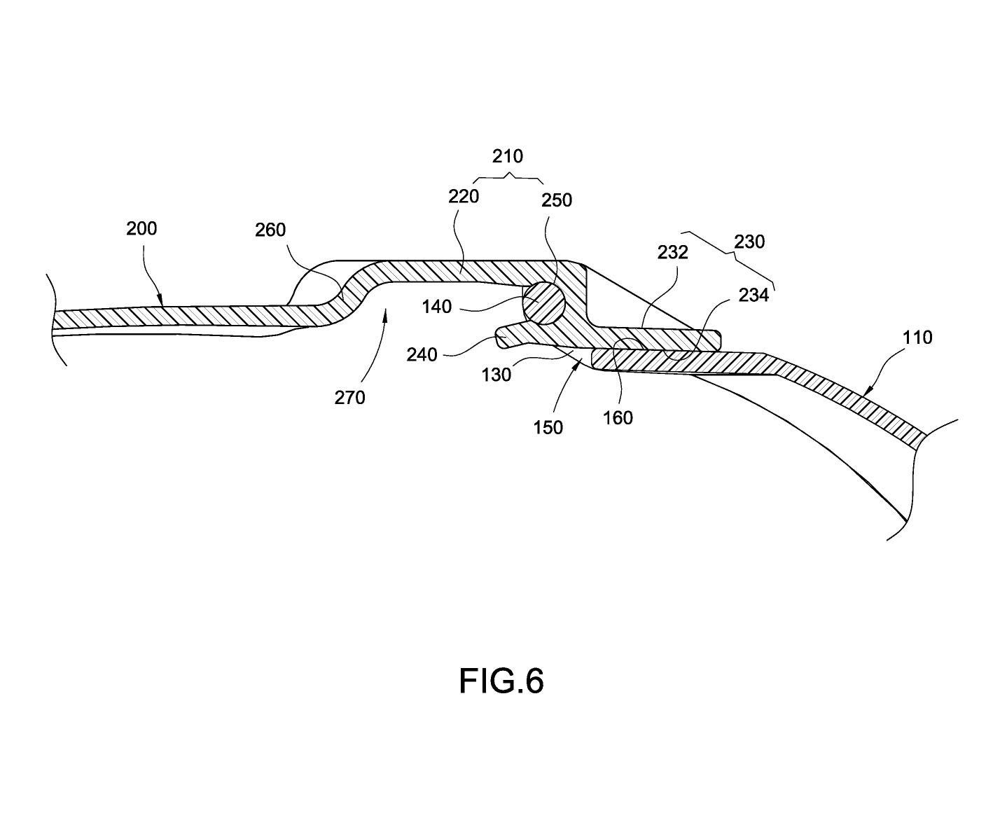

Referring to FIGS. 5 and 6, an end portion of the guiding plate 240 is inclined away from the body 220 to facilitate engagement with the assembly pillar 140. Each leg 200 includes a bend portion 260 for enhancing its strength and improving its appearance, and the bend portion 260 is bent from the body 220 toward the guiding plate 240. Each of the legs 200 further includes a groove 270 in communication with the slot 250, and the groove 270 is formed between the bend portion 260 and the body 220. The connection plate 230 further includes a press surface 232 and a block surface 234 disposed corresponding to each other. The press surface 232 is configured to be pressed by an operator. The frame 110 includes a recess 160 disposed corresponding to the block surface 234. The recess 160 is preferably formed of a wall surface. When the block surface 234 makes surface contact with the wall surface, the leg 200 is limited by the frame 110, and thereby excessive rotation of the leg 200 is prevented, so that the leg 200 can be fastened securely and effectively.

A detailed description about assembling the leg 200 to the frame 110 is provided below. As shown in FIG. 5, first, the connection unit 210 of the leg 200 is fastened to the fastening unit 120 of the frame 110. That is to say, the guiding plate 240 of the connection unit 210 is inserted through the assembly hole 150 to be engaged with the assembly pillar 140 of the fastening unit 120. In other words, the connection plate 230 of the leg 200 forms an included angle θ with respect to the frame 110. The included angle θ is in a range from 80 to 120 degrees, and is preferably 90 degrees.

An edge of each of the two support arms 130 is flush with one side of the assembly pillar 140, so that the body 220 of leg 200 can easily contact one side of the two support arms 130 and the assembly pillar 140, as shown in FIG. 3. Furthermore, when the guiding plate 240 is engaged with the assembly pillar 140, the two fulcrum positioning portions 222 of the body 220 contact the edges of the two support arms 130. Therefore, when the leg 200 is rotatably assembled to the frame 110, the leg 200 is pivoted about the two fulcrum positioning portions 222 as a rotation axis, so as to make the assembly pillar 140 slide into the slot 250 along the guiding plate 240. Accordingly, assembly of the eyeglass structure 100 is completed, as shown in FIG. 4.

Furthermore, when the block surface 234 of the connection plate 230 makes surface contact with the recess 160 (i.e. the wall surface), the leg 200 is limited by the frame 110, and thereby excessive rotation of the leg 200 is prevented, so that the leg 200 can be fastened securely and effectively. As a result, during assembly of the eyeglass structure 100, the leg 200 can be assembled with the frame 110 quickly without screws or any tools, and thus an assembly process is simple and time-efficient.

It is to be understood that the above descriptions are merely the preferable embodiment of the present invention and are not intended to limit the scope of the present invention. Equivalent changes and modifications made in the spirit of the present invention are regarded as falling within the scope of the present invention.

What is claimed is:

1. A screwless eyeglass structure, comprising:
a frame, each of two ends of the frame including a fastening unit, the fastening unit including two support arms, an assembly pillar connected to the two support arms, and an assembly hole adjacent to the assembly pillar; and
two legs, one end of each of the two legs including a connection unit assembled with the fastening unit, the connection unit including a body, a connection plate extending from the body, a guiding plate connected to one end of the connection plate, and a slot disposed in the connection plate, wherein the guiding plate is inserted through the assembly hole to be engaged with the assembly pillar, the connection plate is rotatable with respect to the frame, and the assembly pillar is pivotally connected to the slot.

2. The screwless eyeglass structure of claim 1, wherein each of the two legs further includes two fulcrum positioning portions extending outwardly from two sides of the body, and each of the fulcrum positioning portions is in contact against an edge of the respective corresponding one of the support arms.

3. The screwless eyeglass structure of claim 2, wherein a length of the connection plate is equal to or less than a length of the assembly pillar, and a length between the two fulcrum positioning portions is equal to a length between the two support arms.

4. The screwless eyeglass structure of claim 1, wherein an edge of each of the support arms is flush with one side of the assembly pillar.

5. The screwless eyeglass structure of claim 1, wherein the guiding plate is inclined away from the body.

6. The screwless eyeglass structure of claim 1, wherein each of the legs further includes a bend portion, and the bend portion is bent from the body toward the guiding plate.

7. The screwless eyeglass structure of claim 6, wherein each of the legs further includes a groove in communication with the slot, and the groove is formed between the bend portion and the body.

8. The screwless eyeglass structure of claim 1, wherein the connection plate further includes a press surface and a block surface disposed corresponding to each other.

9. The screwless eyeglass structure of claim 8, wherein the frame further includes a recess disposed corresponding to the block surface, and the block surface makes surface contact with the recess to position the leg.

10. The screwless eyeglass structure of claim 1, wherein the frame further includes two lenses, and each of the two lenses is integrally formed with the frame.

11. The screwless eyeglass structure of claim 1, wherein each of the legs further includes a plurality of pads, and each of the pads protrudes from one side surface of the body.

12. The screwless eyeglass structure of claim 1, wherein the frame and the two legs consist of the same material.

13. The screwless eyeglass structure of claim 1, wherein when the leg is assembled to the frame, and the connection plate of the leg forms an included angle with respect to the frame.

14. The screwless eyeglass structure of claim 13, wherein the included angle is in a range from 80 to 120 degrees.
